(19) United States
(12) Patent Application Publication
(10) Pub. No.: US 2009/0303237 A1
(43) Pub. Date: Dec. 10, 2009

(54) ALGORITHMS FOR IDENTITY ANONYMIZATION ON GRAPHS

(75) Inventors: Kun Liu, San Jose, CA (US); Evimaria Terzi, Palo Alto, CA (US)

Correspondence Address: IP AUTHORITY, LLC;RAMRAJ SOUNDARARAJAN, 4821A Eisenhower Ave, Alexandria, VA, 22304, US

(73) Assignee: International Business Machines Corporation, Armonk, NY (US)

(21) Appl. No.: 12/134,279

(22) Filed: Jun. 6, 2008

(51) Int. Cl. G06T 11/20

(52) U.S. Cl. 345/440

(57) ABSTRACT

The proliferation of network data in various application domains has raised privacy concerns for the individuals involved. Recent studies show that simply removing the identities of the nodes before publishing the graph/social network data does not guarantee privacy. The structure of the graph itself, and in is basic form the degree of the nodes, can be revealing the identities of individuals. To address this issue, a specific graph-anonymization framework is proposed. A graph is called k-degree anonymous if for every node v, there exist at least k−1 other nodes in the graph with the same degree as v. This definition of anonymity prevents the re-identification of individuals by adversaries with a priori knowledge of the degree of certain nodes. Given a graph G, the proposed graph-anonymization problem asks for the k-degree anonymous graph that stems from G with the minimum number of graph-modification operations. Simple and efficient algorithms are devised for solving this problem, wherein these algorithms are based on principles related to the realizability of degree sequences.

### BACKGROUND OF THE INVENTION

1. Field of Invention

The present invention relates generally to the field of privacy breaches in network data. More specifically, the present invention is related to identity anonymization on graphs.

2. Discussion of Related Art

Social networks, online communities, peer-to-peer file sharing and telecommunication systems can be modeled as complex graphs. These graphs are of significant importance in various application domains such as marketing, psychology, epidemiology and homeland security. The management and analysis of these graphs is a recurring theme with increasing interest in the database, data mining and theory communities. Past and ongoing research in this direction has revealed interesting properties of the data and presented efficient ways of maintaining, querying and updating them. However, with the exception of some recent work (see, for example, the paper to Backstrom et al. titled “Wherefore art thou R3579X?: Anonymized social networks, hidden patterns, and structural steganography”, the paper to Hay et al. titled “Anonymizing social networks”, the paper to Pei et al. titled “Preserving privacy in social networks against neighborhood attacks”, the paper to Ying et al titled “Randomizing social networks: a spectrum preserving approach”, and the paper to Zheleva et al. titled “Preserving the privacy of sensitive relationships in graph data”), the privacy concerns associated with graph-data analysis and management have been largely ignored.

In their recent work (in the above-mentioned Backstrom et al. paper), Backstrom et al. point out that the simple technique of anonymizing graphs by removing the identities of the nodes before publishing the actual graph does not always guarantee privacy. It is shown in the previously mentioned Backstrom et al. paper that there exist adversaries that can infer the identity of the nodes by solving a set of restricted isomorphism problems. However, the problem of designing techniques that could protect individuals' privacy has not been addressed in the Backstrom et al. paper.

Hay et al. (in the above-mentioned Hay et al. paper) further observe that the structural similarity of nodes' neighborhood in the graph determines the extent to which an individual in the network can be distinguished. This structural information is closely related to the degrees of the nodes and their neighbors. Along this direction, the authors propose an anonymity model for social networks—a graph satisfies k-candidate anonymity if for every structure query over the graph, there exist at least k nodes that match the query. The structure queries check the existence of neighbors of a node or the structure of the subgraph in the vicinity of a node. However, Hay et al. mostly focus on providing a set of anonymity definitions and studying their properties, and not on designing algorithms that guarantee the construction of a graph that satisfies their anonymity requirements.

Since the introduction of the concept of anonymity in databases in the paper to Samarati et al. titled “Generalizing data to provide anonymity when disclosing information”, there has be increasing interest in the database community in studying the complexity of the problem and proposing algorithms for anonymizing data records under different anonymization models (see, for example, the paper to Bayardo et al. titled “Data privacy through optimal k-anonymization”, the paper to Machanavajjhala et al. titled “1-diversity: privacy beyond k-anonymity”, and the paper to Meyerson et al. titled “On the complexity of optimal k-anonymity”). Though lots of attention has been given to the anonymization of tabular data, the privacy issues of graphs/social networks and the notion of anonymization of graphs have only been recently touched.

Backstrom et al. (in the above-mentioned Backstrom et al. paper) show that simply removing the identifiers of the nodes does not always guarantee privacy. Adversaries can infer the identity of the nodes by solving a set of restricted isomorphism problems, based on the uniqueness of small random subgraphs embedded in an arbitrary network. Hay et al. (in the above-mentioned Hay et al. paper) observe that the structural similarity of the nodes in the graph determines the extent to which an individual in the network can be distinguished. In their recent work, Zheleva and Getoor (in the above-mentioned Zheleva et al. paper) consider the problem of protecting sensitive relationships among the individuals in the anonymized social network. This is closely related to the link-prediction problem that has been widely studied in the link-mining community (see, for example, the paper to Getoor et al. titled “Link mining: a survey”). In the above-mentioned Zheleva et al. paper, simple edge-deletion and node-merging algorithms are proposed to reduce the risk of sensitive link disclosure. Frikken and Golle, in the paper titled “Private social network analysis: how to assemble pieces of a graph privately” study the problem of assembling pieces of graphs owned by different parties privately. They propose a set of cryptographic protocols that allow a group of authorities to jointly reconstruct a graph without revealing the identity of the nodes. The graph thus constructed is isomorphic to a perturbed version of the original graph. The perturbation consists of addition and or deletion of nodes and/or edges.

Whatever the precise merits, features, and advantages of the above cited references, none of them achieves or fulfills the purposes of the present invention.

### SUMMARY OF THE INVENTION

In one embodiment, the present invention provides a computer-based method for generating an anonymous graph of a network while preserving individual privacy and the basic structure of the network, wherein the method comprises the steps of: (a) receiving an input graph G(V,E), wherein V is the set of nodes in the input graph and E is the set of edges in the input graph; (b) determining a degree sequence d of the input graph G(V,E), wherein d is a vector of size n=|V|, such that d(i) represents a degree of the i^{th} node of the input graph G(V,E); (c) applying a programming algorithm to the degree sequence d to construct a new degree sequence \hat{d}, wherein the new degree sequence \hat{d} has an integer k degree of anonymity wherein, for every element v in sequence \hat{d}, there are at least (k−1) other elements taking the same value as v, and wherein the programming algorithm minimizing distance between the degree sequence d and the new degree sequence \hat{d}; (d) constructing an output graph Ĝ(V,Ê) based on the new degree sequence \hat{d}; and (e) outputting the constructed output graph Ĝ(V,Ê), such that Ê ∩ E=E or Ê ∩ E≅E (relaxed version).

Also implemented is an article of manufacture having computer usable medium storing computer readable program code implementing a computer-based method for generating an anonymous graph of a network while preserving individual privacy and the basic structure of the network, wherein the medium comprises: (a) computer readable program code aiding in receiving an input graph G(V,E), wherein V is the set of nodes in the input graph and E is the set of edges in the input graph; (b) computer readable program code determining a degree sequence d of the input graph G(V,E), wherein d is a vector of size n=|V|, such that d(i) represents a degree of the i^{th} node of the input graph G(V,E); (c) computer readable program code applying a programming algorithm to the degree sequence d to construct a new degree sequence \hat{d}, wherein the new degree sequence \hat{d} has an integer k degree of anonymity wherein, for every element v in sequence \hat{d}, there are at least (k−1) other elements taking the same value as v, and wherein the programming algorithm minimizing distance between the degree sequence d and the new degree sequence \hat{d}; (d) computer readable program code constructing an output graph Ĝ(V,Ê) based on the new degree sequence \hat{d}; and (e) computer readable program code aiding in outputting the constructed output graph Ĝ(V,Ê), such that Ê ∩ E=E or Ê ∩ E≈E (relaxed version).

### BRIEF DESCRIPTION OF THE DRAWINGS

FIG. 1 illustrates examples of 3-degree anonymous graph (left) and a 2-degree anonymopus graph (right).

FIG. 2 illustrates a visual illustration of the swap operation.

FIG. 3 illustrates a flow chart of a method associated with the preferred embodiment of the present invention.

FIG. 4a illustrates an example of a computer based system that is used in the generation of an anonymous graph of a network while preserving individual privacy.

FIG. 4b illustrates an embodiment wherein a storage device stores a plurality of modules, wherein the modules collectively are used in the generation of an anonymous graph of a network while preserving individual privacy.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

It should be noted that in a social network, nodes correspond to individuals or other social entities, and edges correspond to social relationships between them. The privacy breaches in social network data can be grouped to three categories: 1) identity disclosure: the identity of the individual which is associated with the node is revealed; 2) link disclosure: the sensitive relationships between two individuals are disclosed; and 3) content disclosure: the privacy of the data associated with each node is breached, e.g., the email message sent and/or received by the individuals in an email communication graph. A perfect privacy-protection system should consider all of these issues. However, protecting against each of the above breaches may require different techniques. For example, for content disclosure, standard privacy-preserving data mining techniques (see, for example, the publication to Aggarwal et al. titled “Privacy-preserving data mining: models and algorithms”, such as data perturbation and k-anonymization can help. For link disclosure, the various techniques studied by the link-mining community (see, for example, previously mentioned papers to Getoor et al. and Zheleva et al.) can be useful.

The present invention focuses on identity disclosure and proposes a systematic framework for identity anonymization on graphs. In order to prevent the identity disclosures of individuals, a new graph-anonymization framework is proposed. More specifically, the following problem is addressed: given a graph G and an integer k, modify G via set of edge-addition (or deletion) operations in order to construct a new k-degree anonymous graph Ĝ, in which every node v has the same degree with at least k−1 other nodes. Of course, one could transform G to the complete graph, in which all nodes would be identical. Although such an anonymization would preserve privacy, it would make the anonymized graph useless for any study. For that reason, an additional requirement is imposed regarding the minimum number of such edge-modifications that can be made. In this way, the utility of the original graph is preserved, while at the same time the degree-anonymity constraint is satisfied.

The present invention assumes that the graph is simple, i.e., the graph is undirected, unweighted, containing no self-loops or multiple edges. The invention also focuses on the problem of edge additions. The case of edge deletions is symmetric and thus can be handled analogously; it is sufficient to consider the complement of the input graph. Also discussed is a recitation of how the present invention's framework can be extended to allow simultaneous edge addition and deletion operations when modifying the input graph.

Let G(V,E) be a simple graph; V is a set of nodes and E the set of edges in G. d_{G} is used to denote the degree sequence of G. That is, d_{G} is a vector of size n=|V| such that d_{G} (i) is the degree of the i-th node of G. Throughout the paper, d(i), d(vᵢ) and d_{G}(i) are used interchangeably to denote the degree of node vᵢ ε V. When the graph is clear from the context, the subscript in notation is dropped and d(i) is used instead. Without loss of generality, it is also assumed that entries in d are ordered in decreasing order of the degrees they correspond to, that is, d (1)≧d (2)≧ . . . ≧d (n). Additionally, for i<j, d [i,j] is used to denote the subsequence of d that contains elements i, i+1, . . . , j−1,j.

Before defining the notion of a k-degree anonymous graph, the notion of a k-anonymous vector of integers is first defined.

DEFINITION 1. A vector of integers v is k-anonymous, if every distinct element value in v appears at least k times.

For example, vector v=[5, 5, 3, 3, 2, 2, 2] is 2-anonymous.

DEFINITION 2. A graph G(V,E) is k-degree anonymous if the degree sequence of G, d_{G}, is k-anonymous.

Alternatively, Definition 2 states that for every node v ε V there exist at least k−1 other nodes that have the same degree as v. This property prevents the re-identification of individuals by adversaries with a priori knowledge of the degree of certain nodes. This echoes the observation made in the previously mentioned paper to Hay et al. Gₖ is used to denote the set of all possible k-degree anonymous graphs with n nodes.

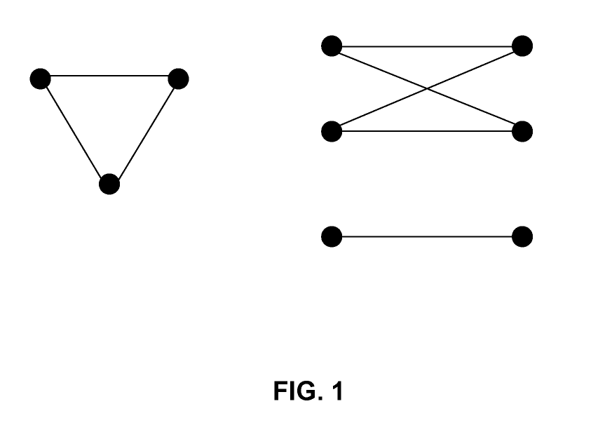

FIG. 1 shows two examples degree-anonymous graphs. In the graph on the left, all three nodes share the same degree and thus the graph is 3-degree anonymous. Similarly, the graph on the right is 2-degree anonymous since there are two nodes with degree 1 and four nodes with degree 2.

Degree anonymity has the following monotonicity property.

PROPOSITION 1. If a graph G(V,E) is k₁-degree anonymous, then it is also k₂-degree anonymous, for every k₂≦k₁.

The definitions above are used to define the GRAPH ANONYMIZATION problem. The input to the problem is a simple graph G(V,E) and an integer k. The requirement is to use a set of graph modification operations on G in order to construct a k-degree anonymous graph G(\hat{V},Ê) that is structurally similar to G. The output graph is required to be over the same set of nodes as the original graph, that is, \hat{V}=V. Moreover, the graph-modification operations are restricted to edge additions; graph Ĝ is constructed from G by adding a (minimal) set of edges. The cost of anonymizing G is called by constructing Ĝ the graph anonymization cost G_{A} and it is computed by G_{A}(Ĝ,G)=|Ê|−|E|.

Formally, GRAPH ANONYMIZATION is defined as follows:

PROBLEM 1 (GRAPH ANONYMIZATION). Given a graph G(V,E) and an integer k, find a k-degree anonymous graph Ĝ (V,Ê) with E ⊂ Ê such that G_{A}(Ĝ, G) is minimized.

Note that the GRAPH ANONYMIZATION problem always has a feasible solution. In the worst case, all edges not present in the input graph can be added. In this way, the graph becomes complete and all nodes share the same degree; thus, any degree-anonymity requirement is satisfied (due to Proposition 1).

However, in the formulation of Problem 1, the k-degree anonymous graph that incurs the minimum graph-anonymization cost has to be found. That is, the minimum number of edges needs to be added to the original graph to obtain a k-degree anonymous version of it. The least number of edges constraint tries to capture the requirement of structural similarity between the input and output graphs. Note that minimizing the number of additional edges can be translated into minimizing the L₁ distance of the degree sequences of G and Ĝ, since it holds that

$$GA ( \hat{G} , G ) = \vert \hat{E} \vert - \vert E \vert = \frac{1}{2} {L}_{1} ( \hat{d} - d ) \qquad ( 1 )$$

It is possible that Problem 1 can be modified so that it allows only for edge deletions, instead of additions. It can be easily shown that solving the latter variant is equivalent to solving Problem 1 on the complement of the input graph. Therefore, all results carry over to the edge-deletion case as well. The generalized problem where simultaneous additions and deletions of edges are allowed so that the output graph is k-degree anonymous is another natural variant.

In general, requiring that Ĝ (V,Ê) is a supergraph of the input graph G(V,E) is a rather strict constraint. It is shown that this requirement can be naturally relaxed to the one where Ê ∩ E≈E. rather than Ê ∩ E=E. This problem is called the RELAXED GRAPH ANONYMIZATION problem and a set of algorithms are developed for this relaxed version. The degree-anonymous graphs obtained in this case are very similar to the original input graphs.

A two-step approach is proposed for the GRAPH ANONYMIZATION problem and its relaxed version. For an input graph G(V,E) with degree sequence d and an integer k:

1. First, starting from d, a degree sequence \hat{d} is constructed that is k-anonymous and the degree-anonymization cost

DA(\hat{d},d)=L₁(\hat{d}−d),

is minimized.

2. Given the new degree sequence \hat{d}, a graph Ĝ (V,Ê) is constructed such that \hat{d}=d_{Ĝ} and E ∩ Ê=E (or E ∩ Ê≈E in the relaxed version).

Note that step 1 requires L₁(\hat{d}−d) to be minimized, which in fact translates into the requirement of the minimum number of edge additions due to Equation 1. Step 2 tries to construct a graph with degree sequence \hat{d}, which is a supergraph (or has large overlap in its set of edges) with the original graph. If \hat{d} is the optimal solution to the problem in Step 1 and Step 2 outputs a graph with degree sequence \hat{d}, then the output of this two-step process is the optimal solution to the GRAPH ANONYMIZATION problem.

Therefore, solving the GRAPH ANONYMIZATION and its relaxed version reduces to performing Steps 1 and 2 as described above. These two steps give rise to two problems, which is formally defined and solved in subsequent sections. Performing step 1 translates into solving the DEGREE ANONYMIZATION defined as follows.

PROBLEM 2 (DEGREE ANONYMIZATION). Given d, the degree sequence of graph G(V,E), and an integer k, construct a k-anonymous sequence \hat{d} such that L₁(\hat{d}−d) is minimized.

Similarly, performing step 2 translates into solving the GRAPH CONSTRUCTION problem that is defined below.

PROBLEM 3 (GRAPH CONSTRUCTION). Given graph G(V,E) and a k-anonymous degree sequence \hat{d}, construct graph Ĝ (V,Ê) such that \hat{d}=d_{G} and {E ∩ Ê}=E (or E ∩ Ê≈E in the relaxed version).

In the next sections, algorithms are developed for solving Problems 2 and 3. There are cases where the optimal k-degree anonymous graph Ĝ* cannot be found. In these cases, a k-degree anonymous graph Ĝ is found that has cost G_{A}(Ĝ,G)≧GA(Ĝ*,G) but as close to G_{A}(Ĝ*,G) as possible.

Degree Anonymization

In this section, algorithms for solving the DEGREE ANONYMIZATION problem are considered. Given the degree sequence d of the original input graph G(V,E), the algorithms output a k-anonymous degree sequence \hat{d} such that the degree-anonymization cost D_{A}(d)=L₁(\hat{d}−d) is minimized.

A dynamic programming algorithm (DP) is first given that solves the DEGREE ANONYMIZATION problem optimally in time O(n²). Then, a discussion is provided regarding how to modify it to achieve linear-time complexity. For completeness, a fast greedy algorithm is also given that runs in time O(nk).

In Problem 1, edge-addition operations are considered. Thus, the degrees of the nodes can only increase in the DEGREE ANONYMIZATION problem. That is, if d is the original sequence and \hat{d} is the k-anonymous degree sequence, then for every 1≦i≦n, \hat{d} (i)≧d (i). Accordingly, the following observation is made.

OBSERVATION 1. Consider a degree sequence d, with d (1)≧ . . . ≧d (n), and let \hat{d} be the optimal solution to the DEGREE ANONYMIZATION problem with input d. If \hat{d} (i)=\hat{d} (j), with i<j, then \hat{d} (i)=\hat{d} (i+1)= . . . =\hat{d} (j−1)=\hat{d} (j).

Given a (sorted) input degree sequence d, let D_{A} (d [1,i]) the degree anonymization cost of subsequence d [1,i]. Additionally, let I (d [i,j]) be the degree anonymization cost when all nodes i, i+1, . . . , j are put in the same anonymized group. Alternatively, this is the cost of assigning to all nodes {i, . . . , j} the same degree, which by construction will be the highest degree, in this case d (i), or

$$I ( d [ i , j ] ) = {\sum }_{l = i}^{j} ( d ( i ) - d ( l ) )$$

Using Observation 1 a set of dynamic programming equations can be constructed to solve the GRAPH ANONYMIZATION problem. That is,

for i<2k,

DA(d[1,i])=I(d[1,i]) (2)

For i≧2k,

$$DA ( d [ l , i ] ) = min \{ \begin{matrix}min \\ k \leq t \leq i - k\end{matrix} \{ DA ( d [ 1 , t ] ) + I ( d [ t + 1 , i ] ) \} , I ( d [ 1 , i ] ) \} \qquad ( 3 )$$

When i<2k, it is impossible to construct two different anonymized groups each of size k. As a result, the optimal degree anonymization of nodes 1, . . . , i consists of a single group in which all nodes are assigned the same degree equal to d (1).

Equation (3) handles the case where i≧2k. In this case, the degree-anonymization cost for the subsequence d [1, i] consists of optimal degree-anonymization costs of the subsequence d [1, t], plus the anonymization cost incurred by putting all nodes t+1, . . . i in the same group (provided that this group is of size k or larger). The range of variable t as defined in Equation (3) is restricted so that all groups examined, including the first and last ones, are of size at least k.

Running time of the DP algorithm: For an input degree sequence of size n, the running time of the DP algorithm that implements Recursions (2) and (3) is O(n²). First, the values of I (d [i, j]) for all i<j can be computed in an O(n²) preprocessing step. Then, for every i the algorithm goes through at most n−2k+1 different values of t for evaluating the Recursion (3). Since there are O(n) different values of i, the total running time is O(n²).

The issue of how to improve the running time of the DP algorithm from O(n²) to O(nk) is now addressed. The core idea for this speedup lies in the simple observation that no anonymous group should be of size large than 2k−1. If any group is larger than or equal to 2k, it can be broken down into two subgroups with equal or lower overall degree-anonymization cost. The proof of this observation is rather simple and is omitted due to space constraints. Using this observation, the preprocessing step that computes the values of I (d [i, j]) does not have to consider all the combinations of (i, j) pairs, but for every i consider only j's such that k≦j−i+1≦2k−1. Thus, the running time for this step drops to O(nk).

Similarly, for every i, not all t's are considered in the range k≦t≦i−k as in Recursion (3), but only t's in the range max {k, i−2k+1}≦t≦i−k. Therefore, Recursion (3) can be rewritten as follows:

$$DA ( d [ 1 , i ] ) = \begin{matrix}min \\ max \{ k , i - 2 k + 1 \} \leq t \leq i - k\end{matrix} \{ DA ( d [ 1 , t ] ) + I ( d [ t + 1 , i ] ) \} \qquad ( 4 )$$

For this range of values of t, the first group has size at least k, and the last one has size between k and 2k−1. Therefore, for every i the algorithm goes through at most k different values of t for evaluating the new recursion. Since there are O(n) different values of i, the overall running time of the DP algorithm is O(nk).

Therefore:

THEOREM 1. Problem 2 can be solved in polynomial time using the DP algorithm described above.

In fact, in the case where only edge additions or deletions are considered, simultaneous edge additions and deletions are not consider, and the running time of the DP algorithm can be further improved to O(n). That is, the running time can become linear in n but independent of k. This is due to the fact that the value of DA (d[1, i′]) given in Equation (4) is decreasing in t for i′ sufficiently larger than i. This means that for every i, not all integers t in the interval [max{k, i−2k+1}, i−k] are candidate for boundary points between groups. In fact, we only need to keep a limited number of such points and their corresponding degree-anonymization costs calculated as in Equation (4). With careful bookkeeping, the factor k can be gotten rid of in the running time of the DP algorithm.

For completeness, a Greedy linear-time alternative algorithm is also provided for the DEGREE ANONYMIZATION problem. Although this algorithm is not guaranteed to find the optimal anonymization of the input sequence, experiments show that it performs extremely well in practice, achieving anonymizations with costs very close to the optimal.

The Greedy algorithm first forms a group consisting of the first k highest-degree nodes and assigns to all of them degree d (1). Then it checks whether it should merge the (k+1)-th node into the previously formed group or start a new group at position (k+1). For taking this decision the algorithm computes the following two costs:

C_{merge}=(d(1)−d(k+1))+I(d[k+2,2k+1])

and

C_{new}=I(d[k+1,2k])

If C_{merge} is greater than C_{new}, a new group starts with the (k+1)-th node and the algorithm proceeds recursively for the sequence d [k+1, n]. Otherwise, the (k+1)-th node is merged to the previous group and the (k+2)-th node is considered for merging or as a starting point of a new group. The algorithm terminates after considering all n nodes.

Running time of the Greedy algorithm: For degree sequences of size n, the running time of the Greedy algorithm is O(nk); for every node i, Greedy looks ahead at O(k) other nodes in order to make the decision to merge the node with the previous group or to start a new group. Since there are n nodes, the total running time is O(nk).

Graph Construction

In this section, algorithms are presented for solving the GRAPH CONSTRUCTION problem. Given the original graph G(V,E) and the desired k-anonymous degree sequence \hat{d} output by the DP (or Greedy) algorithm, a k-degree anonymous graph Ĝ(V,Ê) is constructed with E ⊂ Ê and degree sequence d_{Ĝ} with d_{Ĝ}=\hat{d}.

Basics on Realizability of Degree Sequences

Before giving the actual algorithms for the GRAPH CONSTRUCTION problem, some known facts about the realizability of degree sequences for simple graphs are first addressed. Later on, these results are extended to the current problem setting.

DEFINITION 3. A degree sequence d, with d (1)≧, . . . , ≧d (n) is called realizable if and only if there exists a simple graph whose nodes have precisely this sequence of degrees.

Erdös et al. in the paper titled “Graphs with prescribed degrees of freedom” have stated the following necessary and sufficient condition for a degree sequence to be realizable.

LEMMA 1. ([5]) A degree sequence d with d (1)≧ . . . ≧d (n) and Σᵢ d (i) even, is realizable if and only if for every 1≦l≦n−1 it holds that

$${\sum }_{i = 1}^{l} d ( i ) \leq l ( l - 1 ) + {\sum }_{i = l + 1}^{n} min \{ l , d ( i ) \} \qquad ( 5 )$$

Informally, Lemma 1 states that for each subset of the l highest-degree nodes, the degrees of these nodes can be “absorbed” within the nodes and the outside degrees. The proof of Lemma 1 is inductive and it provides a natural construction algorithm, which is called ConstructGraph (see Algorithm 1 below for the pseudocode).

The ConstructGraph algorithm takes as input the desired degree sequence d and outputs a graph with exactly this degree sequence, if such graph exists. Otherwise it outputs a “No” if such graph does not exist. The algorithm is iterative and in each step it maintains the residual degrees of vertices. In each iteration it picks an arbitrary node v and adds edges from v to d (v) nodes of highest residual degree, where d (v) is the residual degree of v. The residual degrees of these d (v) nodes are decreased by one. If the algorithm terminates and outputs a graph, then this graph has the desired degree sequence. If at some point in the algorithm cannot make the required number of connections for a specific node, then it outputs “No” meaning that the input degree sequence is not realizable.

Note that the ConstructGraph algorithm is an oracle for the realizability of a given degree sequence; if the algorithm outputs “No” then this means that there does not exist a simple graph with the desired sequence.

Algorithm 1 The ConstructGraph algorithm.

Input: A degree sequence d of length n.
Output: A graph G(V, E) with nodes having degree sequence d or

“No” if the input sequence is not realizable.

| | |
|---|---|
| 1: | V ← {1, ..., n}, E ← Φ |
| 2: | if Σᵢ d (i) is odd then |
| 3: | Halt and return “No” |
| 4: | while 1 do |
| 5: | if there exists d (i) such that d (i) < 0 then |
| 6: | Halt and return “No” |
| 7: | if the sequence d are all zeros then |
| 8: | Halt and return G(V,E) |
| 9: | Pick a random node v with degree d (v) > 0 |
| 10: | Set d (v) = 0 |
| 11: | V ← V ∪ {v} |
| 12: | V_{d(v)} ← the d (v) − highest entries in d (other than v) |
| 13: | for each node w ε V_{d(v)} do |
| 14: | E ← E ∪ (v, w) |
| 15: | d (w) ← d (w) − 1 |

Running time of the ContructGraph algorithm: If n is the number of nodes in the graph and dₘₐₓ=maxᵢ d (i), then the running time of the ConstructGraph algorithm is O(ndₘₐₓ). This running time can be achieved by keeping an array A of size dₘₐₓ such that A[d (i)] keeps a hash table of all nodes of degree d (i). Updates to this array (degree changes and node deletions) can be done in constant time. For every node i at most dₘₐₓ constant-time operations are required. Since there are n nodes the running time of the algorithm is O(ndₘₐₓ). In worst case, dₘₐₓ can be of order O(n), and in this case the running time of the ConstructGraph algorithm is quadratic. In practice, dₘₐₓ is much less than n, which makes the algorithm very efficient in practical settings.

Note that the random node in Step 9 of Algorithm 1 can be replaced by either the current highest-degree node or the current lowest-degree node. When starting with higher degree nodes, topologies that have very dense cores are obtained. When starting with lower degree nodes, topologies with very sparse cores are obtained. A random pick is a balance between the two extremes. The running time is not affected by this choice, due to the data structure A.

Realizability of Degree Sequence with Constraints

Notice that Lemma 1 is not directly applicable to the GRAPH CONSTRUCTION problem. This is because not only does a graph Ĝ need to be constructed with a given degree sequence \hat{d}, but also required is the following criteria: E ⊂ Ê. These two requirements are captured in the following definition of realizability of \hat{d} subject to graph G.

DEFINITION 4. Given input graph G(V,E), the degree sequence \hat{d} is realizable subject to G, if and only if there exists a simple graph Ĝ(V,Ê) whose nodes have precisely the degrees suggested by \hat{d} and E ⊂ Ê.

Given the above definition, the following alternative of Lemma 1 is proposed.

LEMMA 2. Consider degree sequence \hat{d} and graph G(V,E) with degree sequence d. Let vector a=\hat{d}−d such that Σᵢ a(i) is even. If \hat{d} is realizable subject to graph G then

$${\sum }_{i ∈ {V}_{1}} a ( i ) \leq {\sum }_{i ∈ {V}_{1}} ( l - 1 - {d}^{1} ( i ) ) + {\sum }_{i ∈ V - {V}_{i}} min \{ l - {d}^{1} ( i ) , a ( i ) \} \qquad ( 6 )$$

where d^{l} (i) is the degree of node i in the input graph G when counting only edges in G that connecte node i to one of the nodes in V₁. Here V₁ is an ordered set of l nodes with the l largest a(i) values, sorted in decreasing order. In other words, for every pair of nodes (u,v) where u ε Vᵢ and v ε V−Vᵢ it holds that a(u)≧a(v) and |Vₗ=l.

One can see the similarity between Inequalities (5) and (6); if G is a graph with no edges between its nodes, then a is the same as \hat{d}, d^{l} (i) is zero, and the two inequalities become identical.

Lemma 2 states that Inequality (6) is just a necessary condition for realizability subject to the input graph G. Thus, if Inequality (6) does not hold, it is concluded that for input graph G(V,E), there does not exist a graph Ĝ(V,Ê) with degree sequence \hat{d} such that E ⊂ Ê.

Although Lemma 2 gives only a necessary condition for realizability subject to an input graph G, an algorithm still needs to be devised for constructing a degree-anonymous graph Ĝ, a supergraph of G, if such a graph exists. This algorithm is called the Supergraph, which is an extension of the ConstructGraph algorithm.

The inputs to the Supergraph are the original graph G and the desired k-anonymous degree sequence \hat{d}. The algorithm operates on the sequence of additional degrees a=\hat{d}−d_{G} in a manner similar to the one the ConstructGraph algorithm operates on the degrees d. However, since Ĝ is drawn on top of the original graph G, an additional constraint exists that edges already in G cannot be drawn again.

The Supergraph first checks whether Inequality (6) is satisfied and returns “No” if it does not. Otherwise, it proceeds iteratively and in each step it maintains the residual additional degrees a of the vertices. In each iteration, it picks an arbitrary vertex v and adds edges from v to a(v) vertices of highest residual additional degree, ignoring nodes v′ that are already connected to v in G. For every new edge (v, v′), a(v′) is decreased by 1. If the algorithm terminates and outputs a graph, then this graph has degree sequence \hat{d} and is a supergraph of the original graph. If the algorithm does not terminate, then it outputs “Unknown”, meaning that there might exist a graph, but the algorithm is unable to find it. Though Supergraph is similar to ConstructGraph, it is not an oracle. That is, if the algorithm does not return a graph Ĝ, which is a supergraph of G, it does not necessarily mean that such a graph does not exist.

For degree sequences of length n and aₘₐₓ=maxᵢ a(i) the running time of the Supergraph algorithm is O(naₘₐₓ), using the same data-structures as those described in Section titled ‘Basics on Reliability of Degree Sequences’.

The Probing Scheme

If the Supergraph algorithm returns a graph Ĝ, then not only does the algorithm guarantee that this graph is the k-degree anonymous but also that the least number of edge additions has been made.

If Supergraph returns “No” or “Uknown”, some more edge-additions can be tolerated in order to get a degree-anonymous graph. For that, a Probing scheme is introduced that forces the Supergraph algorithm to output the desired k-degree anonymous graph with a little extra cost. This scheme is in fact a randomized iterative process that tries to slightly change the degree sequence \hat{d}. The pseudocode of the Probing scheme is shown in Algorithm 2.

Algorithm 2 The Probing scheme.

| | Input: Input graph G(V,E) with degree sequence d and integer k. |
|---|---|
| | Output: Graph Ĝ(V,Ê) with k-anonymous degree sequence \hat{d}, such |
| | that E ⊂ Ê. |
| 1: | \hat{d} = DP( d ) /* or Greedy ( d ) */ |
| 2: | (realizable, Ĝ ) = Supergraph ( \hat{d} ) |
| 3: | while realizable = “No” or “Uknown” do |
| 4: | d = d + random_noise |
| 5: | \hat{d} = DP( d ) /* or Greedy( d ) */ |
| 6: | (realizable, Ĝ ) = Supergraph ( \hat{d} ) |
| 7: | return Ĝ |

For input graph G(V,E) and integer k, the Probing scheme first constructs the k-anonymous sequence \hat{d} by invoking the DP (or Greedy) algorithm. If the subsequent call to the Supergraph algorithm returns a graph Ĝ, the Probing outputs this graph and halts. If Supergraph returns “No” or “Unknown”, then Probing slightly increases some of the entries in d via the addition of uniform noise—the specifics of the noise-addition strategy is further discussed in the next paragraph. The new noisy version of d is then fed as input to the DP (or Greedy) algorithm again. A new version of the \hat{d} is thus constructed and input to the Supergraph algorithm to be checked. The process of noise addition and checking is repeated until a graph is output by Supergraph. Note that this process will always terminate because in worst case, the noisy version of d will contain all entries equal to n−1, and there exists a complete graph that satisfies this sequence and is k-degree anonymous with E ⊂ Ê.

Since the Probing procedure will always terminate, the key question is how many times the while loop is executed. This depends, to a large extent, on the noise addition strategy. In the current implementation, the nodes are examined in increasing order of their degrees, and slightly increase the degree of a single node in each iteration. This strategy is suggested by the degree sequences of the input graphs. In most of these graphs, there is a small number of nodes with very high degrees. However, rarely any two of these high-degree nodes share exactly the same degree. In fact, big differences are observed among them. On the contrary, in most graphs there is a large number of nodes with the same small degrees (close to 1). Given such a graph, the DP (or Greedy) algorithm will be forced to increase the degrees of some of the large-degree nodes a lot, while leaving the degrees of small-degree nodes untouched. In the anonymized sequence thus constructed, a small number of high-degree nodes will need a large number of nodes to connect their newly added edges. However, since the degree of small-degree nodes does not change in the anonymized sequence, the demand of edge end-points imposed by the high-degree nodes cannot be facilitated. Therefore, by slightly increasing the degrees of small-degree nodes in d the DP (or Greedy) algorithm is forced to assign them higher degrees in the anonymized sequence \hat{d}. In that way, there are more additional free edges end-points to connect with the anonymized high-degree nodes.

From experimentation on a large spectrum of synthetic and realworld data, it is observed that, in most cases, the extra edge-additions incurred by the Probing procedure are negligible. That is, the degree sequences produced by the DP (or Greedy) are almost realizable, and more importantly, realizable with respect to the input graph G. Therefore, the Probing is rarely invoked, and even if it is invoked, only a very small number of repetitions are needed.

Relaxed Graph Construction

The Supergraph algorithm presented in the previous section extends the input graph G(V,E), by adding additional edges. It guarantees that the output graph Ĝ(V,Ê) be k-degree anonymous and E ⊂ Ê. However, the requirement that E ⊂ Ê may be too strict to satisfy. In many cases, it is satisfactory to obtain a degree-anonymous graph where Ê ∩ E≈E, which means that most of the edges of the original graph appear in the degree-anonymous graph as well, but not necessarily all of them. This version of the problem is called the RELAXED GRAPH CONSTRUCTION problem.

The Greedy_Swap Algorithm

Let \hat{d} be a k-anonymous degree sequence output by DP (or Greedy) algorithm. Let us additionally assume for now, that \hat{d} is realizable so that the ConstructGraph algorithm with input \hat{d}, outputs a simple graph Ĝ₀(V,Ê₀) with degree sequence exactly \hat{d}. Although Ĝ₀ is k-degree anonymous, its structure may be different from the original graph G(V,E). The Greedy_Swap algorithm is a greedy heuristic that given Ĝ₀ and G, it transforms Ĝ₀ into Ĝ(V,Ê) with degree sequence d_{Ĝ}=\hat{d}=d_{Ĝ}_{₀} and E ∩ Ê≈E.

At every step i, the graph Ĝᵢ₋₁(V,Êᵢ₋₁) is transformed into the graph Ĝᵢ(V,Eᵢ) such that \hat{d}_{Ĝ}_{₀}=\hat{d}_{Ĝ}_{_{i−1}}=\hat{d}_{Ĝ}_{ᵢ}=\hat{d} and |Êᵢ∩E|>|Êᵢ₋₁∩E|. The transformation is made using valid swap operations defined as follows: DEFINITION 5. Consider a graph Ĝᵢ((V,Êᵢ). A valid swap operation is defined by four vertices i, j, k and l of Ĝᵢ(V,Êᵢ) such that (i,k) ε Êᵢ and (j,l) ε Êᵢ and (i,j) ∉ Êᵢ and (k,l) ∉ Êᵢ, or (i,l) ∉ Êᵢ and (J,k) ∉ Êᵢ. A valid swap operation transforms Ĝᵢ to Ĝᵢ₊₁ by updating the edges as follows:

Êᵢ₊₁←Êᵢ\{(i,k), (j,l)}∪{(i,j), (k,l)}, or

Êᵢ₊₁←Êᵢ\{(i,k),(j,l)}∪{(i,l),(j,k)}.

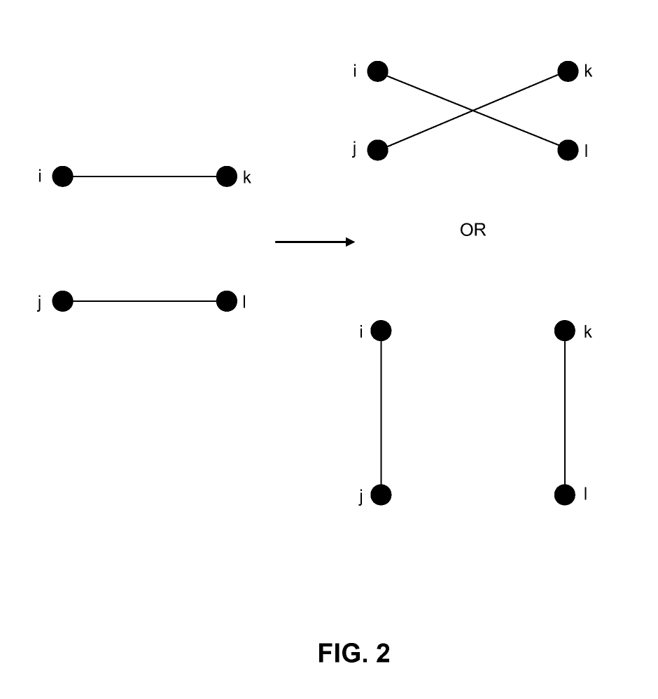

A visual illustration of the swap operation is shown in FIG. 2. It is clear that performing valid swaps on a graph leaves the degree sequence of the graph intact. The pseudocode for the Greedy_Swap algorithm is given in Algorithm 3. At each iteration of the algorithm, the swappable pair of edges e₁ and e₂ is picked to be swapped to edges e′₁ and e′₂. The selection among the possible valid swaps is made so that the pair with maximum (c) increase in the edge intersection is picked. The Greedy_Swap algorithm halts when there are no more valid swaps that can increase the size of the edge intersection.

Algorithm 3 The Greedy_Swap algorithm.

| | Input: An initial graph Ĝ₀(V,Ê₀) and the input graph G(V,E). |
|---|---|
| | Output: Graph Ĝ(V,Ê) with the same degree sequence as |
| | Ĝ₀, such that {E ∩ Ê}≈ E ≈ E. |
| 1: | Ĝ(V,Ê)← Ĝₒ(V,Ê₀) |
| 2. | (c, (e₁, e₂, e′₁, e′₂)) = Find_Max_Swap ( Ĝ ) |
| 3: | while c > 0 do |
| 4: | Ê = Ê \ {e₁, e₂} ∪ {e′₁, e′₂} |
| 5: | (c, (e₁, e₂, e′₁, e′₂)) = Find_Max_Swap |
| 6: | return Ĝ |

Algorithm 4 An overall algorithm for solving the RELAXED GRAPH
CONSTRUCTION problem; the realizable case.

| | Input: A realizable degree sequence \hat{d} of length n. |
|---|---|
| | Output: A graph Ĝ(V,E′)with degree sequence \hat{d} and E ∩ E′ ≈ E. |
| 1: | Ĝ₀ = ConstructGraph ( \hat{d} ) |
| 2: | Ĝ = Greedy_Swap ( Ĝ₀ ) |

Algorithm 4 gives the pseudocode of the whole process of solving the RELAXED GRAPH CONSTRUCTION problem when the degree sequence \hat{d} is realizable. The first step involves a call to the ConstructGraph algorithm. The ConstructGraph algorithm will return a graph Ĝ₀ with degree distribution \hat{d}. The Greedy_Swap algorithm is then invoked with input the constructed graph Ĝ₀. The final output of the process is a k-degree anonymous graph that has degree sequence \hat{d} and large overlap in its set of edges with the original graph.

A naïve implementation of the algorithm would require time O(I|Ê₀|²), where I is the number of iterations of the greedy step and |Ê₀| the number of edges in the input graph. Given that |Ê₀|=O(n²), the running time of the Greedy_Swap algorithm could be O(n⁴), which is daunting for large graphs. However, a simple sampling procedure is employed that considerably improves the running time. Instead of doing the greedy search over the set of all possible edges, uniformly, at random, a subset of size O(log|Ê₀|)=O(log n) of the edges is picked and the algorithm is run on those. This reduces the running time of the greedy algorithm to O(I log² n), which makes it efficient even for very large graphs. The Greedy_Swap algorithm performs very well in practice, even in cases where it starts with graph Ĝ₀ that shares small number of edges with G.

The Probing Scheme for Greedy_Swap: As in the case of the Supergraph algorithm, it is possible that the ConstructGraph algorithm outputs a “No” or “Unknown”. In this case, a Probing procedure is invoked that is identical to the one previously described.

The Priority Algorithm

A simple modification of the ConstructGraph algorithm is provided that allows the construction of degree anonymous graphs with similar high edge intersection with the original graph directly, without using Greedy_Swap. This algorithm is called the Priority algorithm, since during the graph-construction phase, it gives priority to already existing edges in the input graph G(V,E). The intersections obtained using the Priority algorithm are comparable, if not better, to the intersections obtained using the Greedy_Swap algorithm. However, the Priority algorithm is less computationally demanding than the naive implementation of the Greedy_Swap procedure.

The Priority algorithm is similar to the ConstructGraph. Recall that the ConstructGraph algorithm at every step picks a node v with residual degree \hat{d} (v) and connects it to \hat{d} (v) nodes with highest residual degree. Priority works in a similar manner with the only difference that it makes two passes over the sorted degree sequence \hat{d} of the remaining nodes. In the first pass, it considers only nodes v′ such that \hat{d} (v′)>0 and edge (v, v′) ε E. If there are less that \hat{d} (v) such nodes it makes a second pass considering nodes v′ such that d (v′)>0 and edge (v, v′) ∉ E. In that way, Priority tries to connect node v to as many of his neighbors in the input graph G. The graphs thus constructed share lots of edges with the input graph. In terms of running time, the Priority algorithm is the same as ConsructGraph.

In the case where Priority fails to construct a graph by reaching a dead-end in the edge-allocation process, the Probing scheme is employed; and random noise addition is made until the Priority algorithm outputs a valid graph.

Extensions: Simultaneous Edge Additions and Deletions

This section deals with how to extend the above-presented framework to allow simultaneous edge additions and deletions. Similar to what was discussed above, given an input graph G(V,E) with degree sequence d:
1. First, produce a k-degree anonymous sequence \hat{d} from d, such that L₁(\hat{d}−d) is minimized.
2. Then construct graph Ĝ(V,Ê) with degree sequence \hat{d} such that E ∩ Ê is as large as possible.

Step 1 is different from before since the degrees of the nodes in \hat{d} can either increase or decrease when compared to their original values in d. Despite this complication, it is easy to show that a dynamic-programming similar to the one described previously can be used to find such a \hat{d} that minimizes L₁(\hat{d}−d).

The only difference is in the evaluation of I(d[i,j]) that corresponds to L₁ cost of putting all nodes i, i+1, . . . , j in the same anonymized group. In this case,

$$I ( d [ i , j ] ) = {\sum }_{l = i}^{j} \vert {d}^{*} - d ( l ) \vert ,$$

Where d* is the degree d such that

$${d}^{*} = arg \begin{matrix}min \\ d\end{matrix} {\sum }_{l = i}^{j} \vert d - d ( l ) \vert .$$

From Lee's paper entitled “Graphical demonstration of an optimality property of the median”, we know that d* is the median of the values {d(i), . . . , d(j)}, and therefore given i and j, computing I(d[i,j) can be done optimally in linear time. Note that since the entries in d are integers d* is also integer. If (j−i+1) is even, there are two medians. However, it is easy to prove that both of them give the same L₁ cost. In fact, it can be shown that solving Step 1 can be done optimally using a dynamic program similar to the one previously described. The corresponding greedy counterpart is also easy to develop along the same lines as previously proposed.

For Step 2, the previously presented Greedy_Swap algorithm can be considered. Recall that Greedy_Swap constructs a graph Ĝ₀(V,Ê₀) from a degree sequence \hat{d}. The, it transforms Ĝ₀ into Ĝ(V,Ê) with a degree sequence d_{Ĝ}=\hat{d}=d_{Ĝ}_{₀} and E ∩ Ê≈E . This algorithm implicitly allows for both edge-additions and edge-deletions. Thus, this algorithm is adopted for solving Step 2. For simplicity, this combination of the new dynamic programming and Greedy_Swap is called the Simultaneous_Swap algorithm.

The paper by the authors of the current application (Kun Liu and Evimaria Terzi) titled “Towards Identity Anonymization on Graphs,” to be published in the SIGMOD Conference of 2008, attached in Appendix A, provide experimental results for the various proposed graph anonymization algorithms described herein.

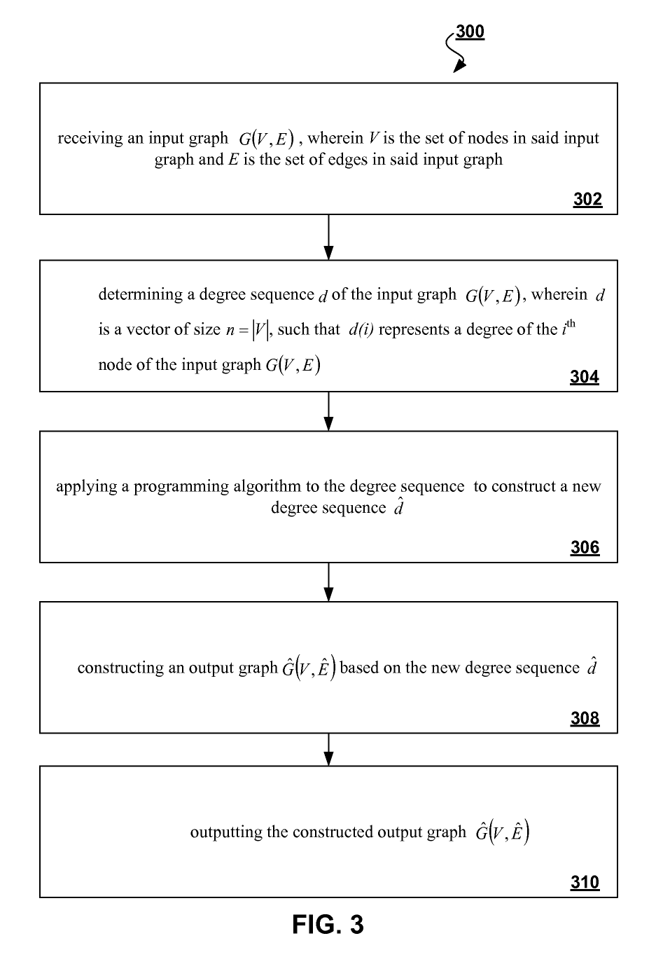

FIG. 3 illustrates a flow chart associated with the preferred embodiment of the present invention. In this embodiment, the present invention's method 300 for generating an anonymous graph of a network while preserving individual privacy and the basic structure of the network comprises the steps of: (a) receiving an input graph G(V,E), wherein V is the set of nodes in the input graph and E is the set of edges in said input graph—step 302; (b) determining a degree sequence d of the input graph G(V,E), wherein d is a vector of size n=|V|, such that d(i) represents a degree of the i^{th} node of the input graph G(V,E)—step 304; (c) applying a programming algorithm to the degree sequence d to construct a new degree sequence \hat{d}, wherein the new degree sequence \hat{d} has an integer k degree of anonymity wherein, for every element v in sequence \hat{d}, there are at least (k−1) other elements taking the same value as v, and wherein said programming algorithm minimizing distance between the degree sequence d and the new degree sequence \hat{d}—step 306; (d) constructing an output graph Ĝ(V,Ê) based on the new degree sequence \hat{d}—step 308; and (e) outputting the constructed output graph Ĝ(V,Ê), such that Ê ∩ E=E or Ê∩ E≈E (relaxed version)—step 310.

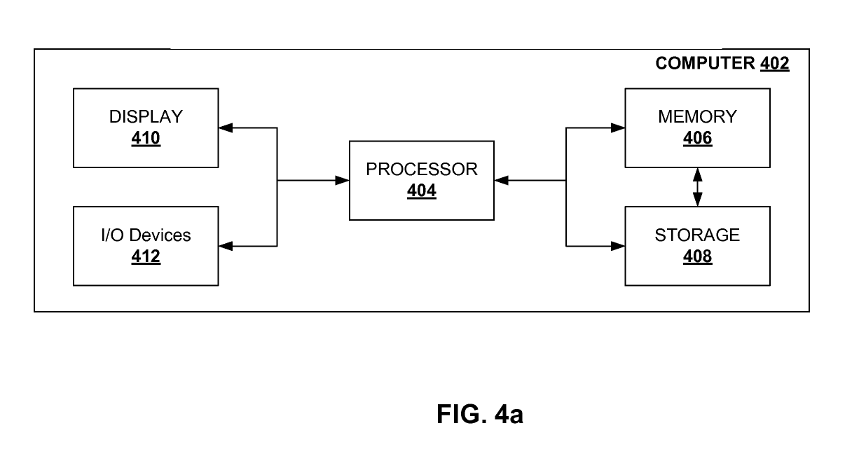

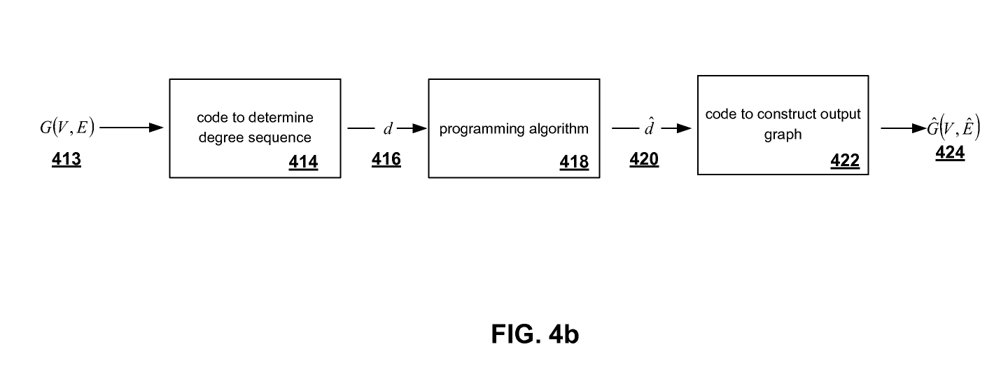

The present invention also provides a computer-based system 402, as shown in FIG. 4a, for generating an anonymous graph of a network while preserving individual privacy and the basic structure of the network. The computer system shown in FIG. 4a comprises processor 404, memory 406, storage 408, display 410, and input/output devices 412. Storage 408 stores computer readable program code implementing one or more modules that help in the generation of an anonymous graph of a network while preserving individual privacy and the basic structure of the network. FIG. 4b illustrates one embodiment wherein storage 408 stores first 414, second 418, and third 422 modules, each of which are implemented using computer readable program code. The first module 414 aids a computer in receiving an input graph G(V,E) 413, wherein V is the set of nodes in said input graph and E is the set of edges in said input graph, wherein the first module 414 determines a degree sequence d 416 of the input graph G(V,E) 413, wherein d 416 is a vector of size n=|V|, such that d(i) represents a degree of the i^{th} node of the input graph G(V,E). The second module 418 applies a programming algorithm to the degree sequence d 416 to construct a new degree sequence \hat{d} 420, wherein the new degree sequence \hat{d} 420 has an integer k degree of anonymity wherein, for every element v in sequence \hat{d}, there are at least (k−1) other elements taking the same value as v, and wherein the second module 418 minimizes the distance between the degree sequence d 416 and the new degree sequence \hat{d} 420. The third module 422 constructs an output graph Ĝ(V,Ê) 424 based on the new degree sequence \hat{d} 420, wherein the third module outputs the constructed output graph Ĝ(V,Ê) 424, such that Ê ∩ E=E or Ê ∩ E≈E (relaxed version).

Additionally, the present invention provides for an article of manufacture comprising computer readable program code contained within implementing one or more modules to implement identity anonymization on graphs. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Also implemented in an article of manufacture having computer usable medium storing computer readable program code implementing a computer-based method for generating an anonymous graph of a network while preserving individual privacy and the basic structure of the network, wherein the medium comprises: (a) computer readable program code aiding in receiving an input graph G(V,E), wherein V is the set of nodes in said input graph and E is the set of edges in said input graph; (b) computer readable program code determining a degree sequence d of the input graph G(V,E), wherein d is a vector of size n=|V|, such that d(i) represents a degree of the i^{th} node of the input graph G(V,E); (c) computer readable program code applying a programming algorithm to the degree sequence d to construct a new degree sequence \hat{d}, wherein the new degree sequence \hat{d} has an integer k degree of anonymity wherein, for every element v in sequence \hat{d}, there are at least (k−1) other elements taking the same value as v, and wherein said programming algorithm minimizing distance between the degree sequence d and the new degree sequence \hat{d}; (d) computer readable program code constructing an output graph Ĝ(V,Ê) based on the new degree sequence \hat{d}; and (e) computer readable program code aiding in outputting the constructed output graph Ĝ(V,Ê), such that Ê ∩ E=E or Ê∩ E≈E (relaxed version).

### CONCLUSION

A system and method has been shown in the above embodiments for the effective implementation of algorithms for identity anonymization on graphs. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A computer-based method for generating an anonymous graph of a network while preserving individual privacy and the basic structure of the network, said method comprising the steps of:
(a) receiving an input graph G(V,E), wherein V is the set of nodes in said input graph and E is the set of edges in the input graph;
(b) determining a degree sequence d of the input graph G(V,E), wherein d is a vector of size n=|V|, such that d(i) represents a degree of the i^{th} node of the input graph G(V,E);
(c) applying a programming algorithm to the degree sequence d to construct a new degree sequence \hat{d}, wherein the new degree sequence \hat{d} has an integer k degree of anonymity wherein, for every element v in sequence \hat{d}, there are at least (k−1) other elements taking the same value as v, and wherein said programming algorithm minimizing distance between the degree sequence d and the new degree sequence \hat{d};
(d) constructing an output graph Ĝ(V,Ê) based on the new degree sequence \hat{d}; and
(e) outputting the constructed output graph Ĝ(V,Ê), wherein Ê is the new set of edges in the output graph, and such that Ê ∩ E=E or Ê ∩ E≈E (relaxed version).

2. The computer-based method of claim 1, wherein said step of determining a degree sequence d of the input graph G(V,E) further comprises the steps of:
computing a degree of each node in the graph G(V,E), wherein the degree of a given node in said set of nodes V indicates a number of edges, within said set of edges E, the given node has to other nodes in said set of nodes V; and
arranging the computed degrees in an array.

3. The computer-based method of claim 2, wherein said step of arranging the degrees in an array further comprises the step of sorting the array in descending order.

4. The computer-based method of claim 1, wherein the new set of edges Ê in the output graph Ĝ(V,Ê) is a superset of the set of edges in the input graph G(V,E).

5. The computer-based method of claim 1, wherein the new set of edges Ê in the output graph Ĝ(V,Ê) contains substantially the same set of edges E as the input graph G(V,E).

6. The computer-based method of claim 1, wherein the input graph G(V,E) corresponds to a computer model of a network.

7. The computer-based method of claim 1, wherein each node in the set of nodes V corresponds to any of the following: an individual or a social entity.

8. The computer-based method of claim 7, wherein each edge in the set of edges E corresponds to a social relationship between individuals or societal entities connected to an edge.

9. The computer-based method of claim 7, wherein each node in the set of nodes V stores personally identifying information associated with said individual.

10. The computer-based method of claim 9, wherein said personally identifying information is any of the following: name, postal address, telephone number, email address, social security number, medical identification number, or an account number.

11. The computer-based method of claim 1, wherein the network is any of the following: a telecommunications network, an online social network, or a peer-to-peer file sharing network.

12. The computer-based method of claim 1, wherein the programming algorithm is a dynamic programming algorithm, with degree-anonymization cost DA calculated as follows:
$$for i < 2 k , DA ( d [ 1 , i ] ) = I ( d [ 1 , i ] ) , and$$
$$for i \geq 2 k , DA ( d [ 1 , i ] ) = min \{ \begin{matrix}min \\ k \leq t \leq i - k\end{matrix} \{ DA ( d [ 1 , t ] ) + I ( d [ t + 1 , i ] ) \} , I ( d [ 1 , i ] ) \}$$

13. The computer-based method of claim 1, wherein the programming algorithm is a greedy linear-time algorithm.

14. The computer-based method of claim 1, wherein the step of constructing an output graph Ĝ(V,Ê) based on the new degree sequence \hat{d}further comprises the steps of:
applying an iterative algorithm based on the new degree sequence \hat{d}; and
outputting a graph Ĝ(V,Ê) having exactly the new degree sequence \hat{d} and Ê ∩ E=E or Ê ∩E≈E (in the relaxed version), otherwise, adding small random noise to the original degree sequence d, computing a new degree sequence \hat{d} that is realizable, and constructing an output graph Ĝ(V,Ê) based on the new degree sequence \hat{d}.

15. An article of manufacture having computer usable medium storing computer readable program code implementing a computer-based method for generating an anonymous graph of a network while preserving individual privacy and the basic structure of the network, said medium comprising:
(a) computer readable program code aiding in receiving an input graph G(V,E), wherein V is the set of nodes in said input graph and E is the set of edges in said input graph;
(b) computer readable program code determining a degree sequence d of the input graph G(V,E), wherein d is a vector of size n=|V|, such that d(i) represents a degree of the i^{th} node of the input graph G(V,E);
(c) computer readable program code applying a programming algorithm to the degree sequence d to construct a new degree sequence \hat{d}, wherein the new degree sequence \hat{d} has an integer k degree of anonymity wherein, for every element v in sequence \hat{d}, there are at least (k−1) other elements taking the same value as v, and wherein said programming algorithm minimizing distance between the degree sequence d and the new degree sequence \hat{d};
(d) computer readable program code constructing an output graph Ĝ(V,Ê) based on the new degree sequence \hat{d}; and
(e) computer readable program code aiding in outputting the constructed output graph Ĝ(V,Ê), and such that Ê ∩ E=E or Ê ∩ E≈E (relaxed version).

16. The article of manufacture of claim 15, wherein said medium further comprises:
computer readable program code computing a degree of each node in the graph G(V,E), wherein the degree of a given node in said set of nodes V indicates a number of edges, within said set of edges E, the given node has to other nodes in said set of nodes V; and
computer readable program code arranging the computed degrees in an array.

17. The article of manufacture of claim 16, wherein said medium further comprises computer readable program code sorting the array in descending order.

18. The article of manufacture of claim 15, wherein the new set of edges Ê in the output graph Ĝ(V,Ê) is a superset of the set of edges in the input graph G(V,E).

19. The article of manufacture of claim 15, wherein the new set of edges Ê in the output graph Ĝ(V,Ê) contains substantially the same set of edges E as the input graph G(V,E).

20. The article of manufacture of claim 15, wherein the input graph G(V,E) corresponds to a computer model of a network.

21. The article of manufacture of claim 15, wherein each node in the set of nodes V corresponds to any of the following: an individual or a social entity, and each edge in the set of edges E corresponds to a social relationship between individuals or societal entities connected to an edge.

22. The article of manufacture of claim 15, wherein the network is any of the following: a telecommunications network, an online social network, or a peer-to-peer file sharing network.

23. The article of manufacture of claim 15, wherein the programming algorithm implemented in computer readable program code is a dynamic programming algorithm, with degree-anonymization cost DA calculated as follows:
$$for i < 2 k , DA ( d [ 1 , i ] ) = I ( d [ 1 , i ] ) , and$$
$$for i \geq 2 k , DA ( d [ 1 , i ] ) = min \{ \begin{matrix}min \\ k \leq t \leq i - k\end{matrix} \{ DA ( d [ 1 , t ] ) + I ( d [ t + 1 , i ] ) \} , I ( d [ 1 , i ] ) \}$$

24. The article of manufacture of claim 15, wherein the programming algorithm implemented in computer readable program code is a greedy linear-time algorithm.

25. The article of manufacture of claim 15, wherein medium further comprises:
computer readable program code applying an iterative algorithm based on the new degree sequence \hat{d}; and
computer readable program code outputting a graph Ĝ(V,Ê) having exactly the new degree sequence \hat{d} and Ê ∩ E=E or Ê ∩ E≈E (in the relaxed version), otherwise,
computer readable program code adding small random noise to the original degree sequence d,
computer readable program code computing a new degree sequence d that is realizable, and
computer readable program code constructing an output graph Ĝ(V,Ê) based on the new degree sequence \hat{d}.
